(19) United States
(12) Patent Application Publication
(10) Pub. No.: US 2026/0065685 A1
(43) Pub. Date: Mar. 5, 2026

(54) Vehicle Position Recognition Using Modified Neural Network

(71) Applicants: The Regents of The University of Michigan, Ann Arbor, MI (US); Budapest University of Technologies and Economics, Budapest (HU)

(72) Inventors: Gabor OROSZ, Ann Arbor, MI (US); Tian MI, Ann Arbor, MI (US); Denes TAKACS, Budapest (HU)

(73) Assignees: The Regents of The University of Michigan, Ann Arbor, MI (US); Budapest University of Technologies and Economics, Budapest (HU)

(21) Appl. No.: 19/312,873

(22) Filed: Aug. 28, 2025

Related U.S. Application Data
(60) Provisional application No. 63/689,489, filed on Aug. 30, 2024.

(51) Int. Cl. G06V 20/54; G06T 7/20; G06T 7/70; G06V 10/25; G06V 10/82; G06V 20/17

(52) U.S. Cl. CPC G06V 20/54; G06T 7/20; G06T 7/70; G06V 10/25; G06V 10/82; G06V 20/17; G06T 2207/10016; G06T 2207/10032; G06T 2207/20081; G06T 2207/20084; G06T 2207/30236; G06V 2201/08

(57) ABSTRACT

A methodology is developed to extract vehicle kinematic information from roadside cameras at an intersection using deep learning. The ground truth data of top view bounding boxes are collected with the help of unmanned aerial vehicles (UAVs). These top view bounding boxes containing vehicle position, size, and orientation information, are converted to the roadside view bounding boxes using homography transformation. The ground truth data and the roadside view images are used to train a modified YOLOv5 neural network, and thus, to learn the homography transformation matrix. The output of the neural network is the vehicle kinematic information, and it can be visualized in both the top view and the roadside view. In this algorithm, the top view images are only used in training, and once the neural network is trained, only the roadside cameras are needed to extract the kinematic information.

### GOVERNMENT CLAUSE

This invention was made with government support under 69A3552348305 awarded by the U.S. Department of Transportation. The government has certain rights in the invention.

### FIELD

The present disclosure relates to vehicle position recognition using a modified neural network or other machine learning models.

### BACKGROUND

The detection of vehicles via real-time image processing is a crucial task not just for autonomous vehicles but also for intersection management systems. However, identifying bounding boxes and extracting vehicle kinematic data (like position, yaw angle, velocity and yaw rate) with satisfying accuracy are challenging problems. In one existing work, the problem is approached through object detection and postprocessing with a trained network. The training data is collected through GPS and LIDAR sensors. In another existing work, it is also possible to estimate the distance of an object based on the size of the bounding box. Instead of focusing on object classification and tracking (position and speed), this disclosure introduces a novel methodology to extract vehicle kinematic data (position, velocity, orientation and yaw rate) with the help of a neural network trained on high-precision data.

This section provides background information related to the present disclosure which is not necessarily prior art.

### SUMMARY

This section provides a general summary of the disclosure, and is not a comprehensive disclosure of its full scope or all of its features.

In one aspect, a method is presented for detecting a vehicle passing through a region of interest. The method includes: capturing, by a side view camera, a set of images for a region of interest on the ground from a perspective on side of the region of interest; providing a neural network model configured to receive images of the region of interest captured from a perspective on side of the region of interest and trained to output vectors representing bounding boxes for each vehicle detected in the region of interest from a perspective above the region of interest, where the vectors include a yaw angle for the bounding boxes and the yaw angle defines orientation of a vehicle on ground plane; and detecting vehicles in the region of interest by inputting the set of images into the neural network model.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flowchart depicting a method for extracting kinematic data for a vehicle from image data.

FIG. 2 is a diagram of an example intersection at a test facility.

FIG. 3A shows image stabilization techniques in accordance with this disclosure.

FIG. 3B shows an object detection technique in accordance with this disclosure.

FIG. 3C shows a vehicle detection technique in accordance with this disclosure.

FIG. 3D shows kinematic data extracted from images in accordance with this disclosure.

FIG. 4 is a diagram of a bicycle model applied to a truck.

FIGS. 5A-5C are graphs showing speed, velocity components, and heading angles and yaw angle of a truck over time, respectively.

FIG. 6 depicts a vehicle position recognition technique using a modified neural network.

FIGS. 7A-7B depict an example output grid of the modified neural network mapped on to the roadside and a top view of the region of interest.

FIGS. 8A-8C show output of the vehicle position recognition technique and its comparison with ground truth data for a roadside view and a top view.

FIGS. 9A-9D are graphs showing the output of the vehicle position recognition technique in relation to ground truth data.

Corresponding reference numerals indicate corresponding parts throughout the several views of the drawings.

### DETAILED DESCRIPTION

Example embodiments will now be described more fully with reference to the accompanying drawings.

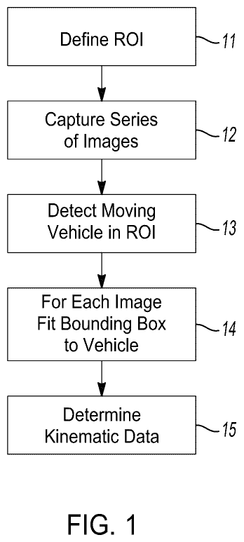

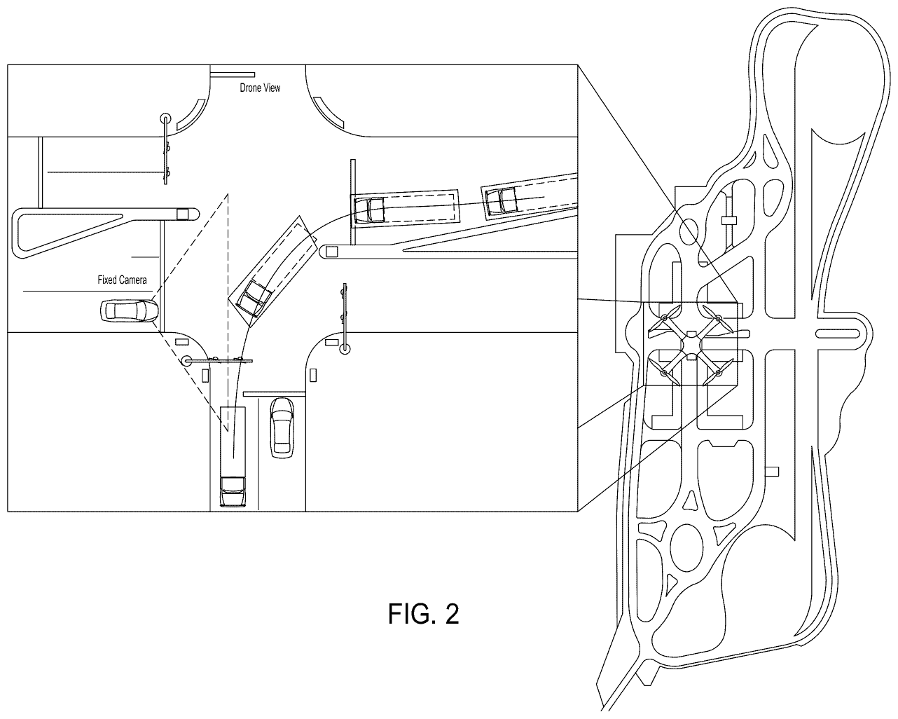

As a starting point, a method is presented for extracting kinematic data for vehicles as depicted in FIG. 1. A region of interest (ROI) is defined as indicated at 11. For demonstration purposes, an experiment was carried out in Mcity Test Facility at the University of Michigan, Ann Arbor. As shown in FIG. 2, the intersection of State Street (north-south) and Main Street (east-west) was chosen for the experiment and designated the region of interest. The experiment is designed as follows. A 26-ft moving truck (Ford F-650) moves towards the intersection from the westbound of Main Street, then makes a left turn to State Street, while a stationary personal vehicle stays at the eastbound of the intersection with its camera facing forward. The truck has an onboard GPS of 10 Hz frequency installed on top of the cabin. There are three other vehicles parked at the intersection to imitate a real environment. A DJI Phantom 4 Pro drone equipped with a video camera of the highest performance of 60 frames per second (fps) is sent above the intersection, of about 250 feet high. The camera is facing down to the intersection in order to record the movements of the vehicles. The effective pixels of the camera is 20M, and it has a 3-axis gimbal for stabilization. The movement of the truck is captured by both the drone camera (top view) and the stationary vehicle's camera (side view).

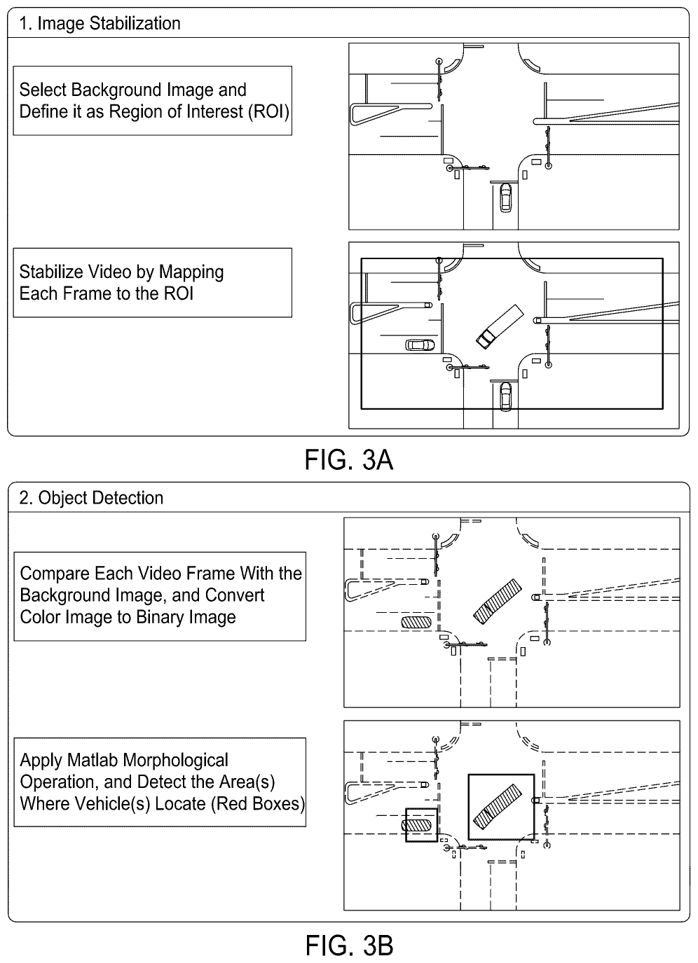

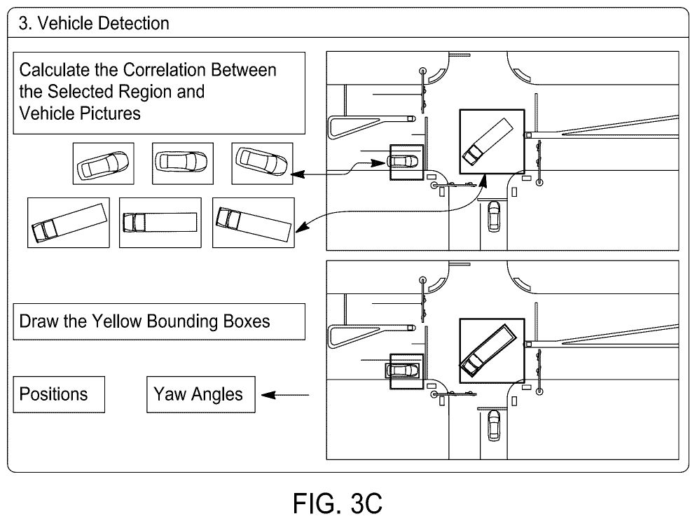

A series of images (i.e., a video) are captured over time by a camera at 12, where each image is of the region of interest from a perspective above the region of interest. For example, the series of images may be captured using an unmanned aerial vehicle, where the unmanned aerial vehicle is equipped with the camera. Prior to object detection, image stabilization is performed as shown in FIG. 3A. In particular, a background image of the intersection is selected from the series of images when the target vehicles are not present, and it is defined as the region of interest (ROI) to map each frame of the video. The use of the background image not only reduces the computation time by eliminating the unnecessary part of the images, but also stabilizes the video obtained from the hovering drone.

From the series of images, at least one vehicle moving in the region of interest is detected at 13. Moving objects can be detected by comparing each frame in the series of images with the background image as shown in FIG. 3B. The comparison results in a binary image. In an example embodiment, morphological operations are applied to eliminate the small changes of the image (due to shadows, moving leaves in the wind, and slight changes of camera perspective, etc.) and to merge the neighboring patches which belong to the same object. The outcomes of this step are the detection boxes (marked as red squares in FIG. 3B), and the number of objects. Note that the detection boxes are square-shaped considering the orientations of the vehicles, and they can be in different sizes according to the actual vehicle sizes. The goal of this step is to find the rough locations of the vehicles and to prepare for the precise vehicle detection. On the one hand, the parked vehicles in the background are not detected. On the other hand, as long as the vehicle is not in the background image, even if it is parked, it can still be detected. The background image can be updated to accommodate larger changes during the day (or different times of the year), but this is not needed in this research since the time of interest is less than a minute. These steps may be implemented using Matlab or other commercially available image processing tools.

For each image in the series of images, a bounding box is fit at 14 to each of the detected moving objects. With reference to FIG. 3C, a detection box surrounds the detected moving object. More specifically, fitting the bounding box to a detected moving object includes overlay a pre-defined image of the object (e.g., a car or a truck) on the detection box; changing orientation of the pre-defined image in relation to the detected moving object; for each orientation, determining a correlation metric between the pre-defined image and the periphery of the detected moving object; and drawing a bounding box around the detected moving object based on the pre-defined image having the correlation metric with highest value. It is noted that the size of the bounding box is the same across a series of images.

Finally, kinematic data for the moving objects can be determined at 15 using the bonding boxes as described below. In an example embodiment, the camera is interfaced with a controller and the controller executes the image processing steps above. It should be understood that the logic for the controller can be implemented in hardware logic, software logic, or a combination of hardware and software logic. In this regard, controller can be or can include any of a digital signal processor (DSP), microprocessor, microcontroller, or other programmable device which are programmed with software implementing the above described methods. It should be understood that alternatively the controller is or includes other logic devices, such as a Field Programmable Gate Array (FPGA), a complex programmable logic device (CPLD), or application specific integrated circuit (ASIC).

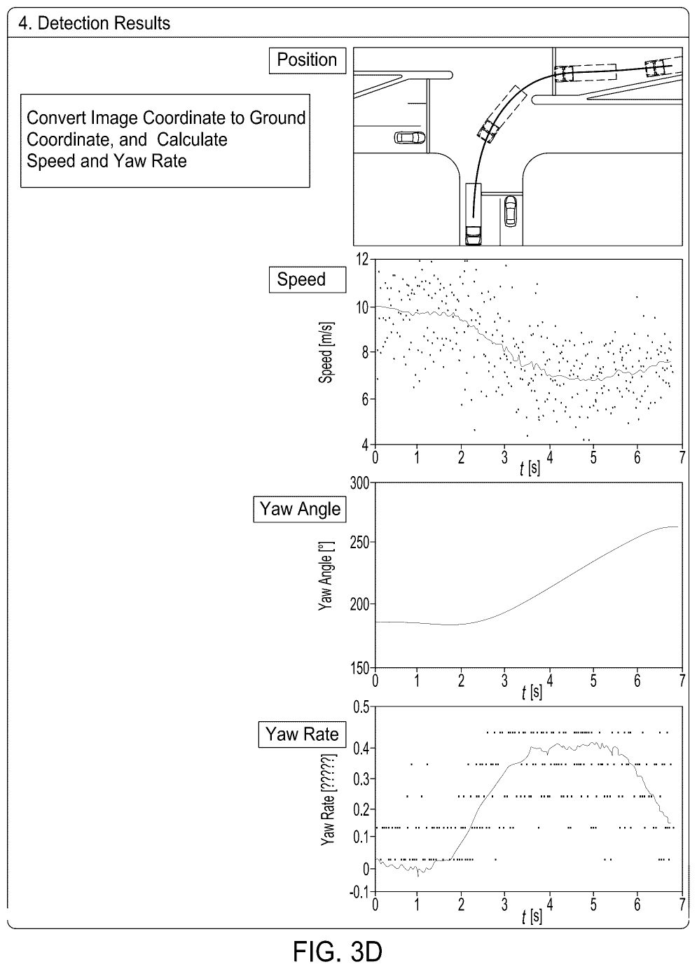

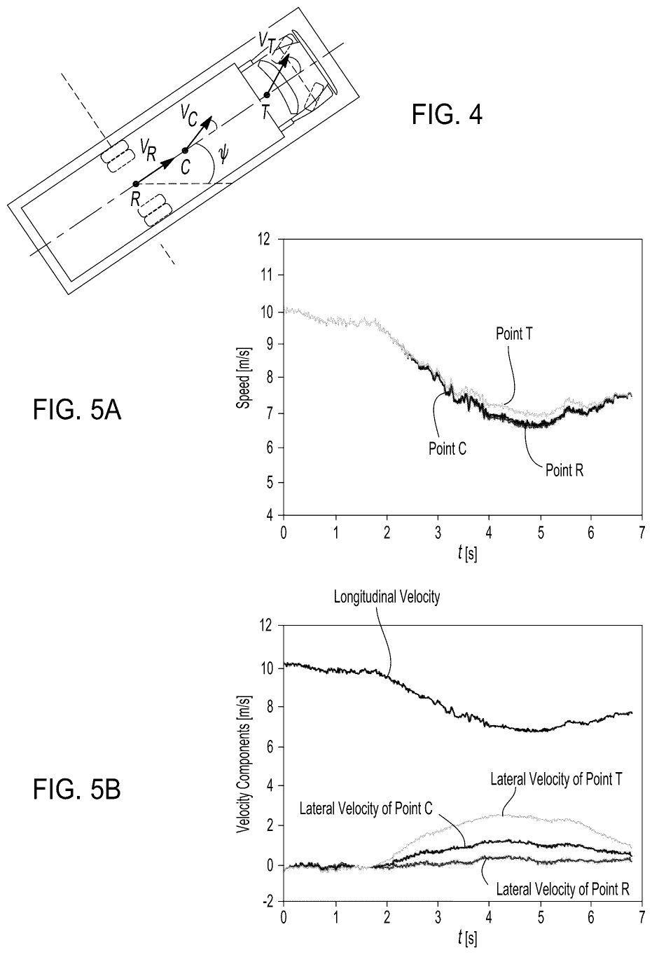

The position and the yaw angle of a moving object can be obtained directly from the bounding box as described below. Taking a truck as an example, apply the bicycle model to the truck as shown in FIG. 4, where Point C is the geometric center of the bounding box, point T is on top of the cabin where the GPS antenna is installed, and point R is the center of the real axle. ν_{T}, ν_{C}, and ν_{R} are the velocities at points T, C, and R, respectively, while β_{T}, β_{C}, and β_{R} are the angles between the velocities and the vehicle longitudinal direction. ψ is the yaw angle of the truck, i.e., the orientation of the truck measured in relation to a fixed reference axis in ground coordinate system. Thus, the yaw angle defines orientation of a vehicle on the ground plane. Note that the heading angle θ is given by the sum of yaw angle ψ and angle β. For example, the heading angle θ_{C} at point C is (ψ+β_{C}). Assuming no side slip for the rear wheel, that is, the velocity at point R is aligned with the vehicle and it only has longitudinal component, β_{R}≈0.

Consider the vehicle as a rigid body, the yaw rate is the same at any point of the body, but the velocity and heading angle are different at different points. The position

$${r}_{C} = [ \begin{matrix}{x}_{C} \\ {y}_{C}\end{matrix} ]$$

of point C and the yaw angle ψ can be directly obtained from the bounding box after converting the image coordinate to a ground coordinate. With the distances measured between point T and center point C is d_{CT}=3.49 m, and between center point C and rear axle center point R is d_{CR}=2.21 m, the positions of point T and point C can be calculated as:

$${r}_{T} = [ \begin{matrix}{x}_{T} \\ {y}_{T}\end{matrix} ] = [ \begin{matrix}{x}_{C} \\ {y}_{C}\end{matrix} ] + {d}_{CT} [ \begin{matrix}cos ψ \\ sin ψ\end{matrix} ] , {r}_{R} = [ \begin{matrix}{x}_{R} \\ {y}_{R}\end{matrix} ] = [ \begin{matrix}{x}_{C} \\ {y}_{C}\end{matrix} ] - {d}_{CR} [ \begin{matrix}cos ψ \\ sin ψ\end{matrix} ] . \qquad ( 1 )$$

Knowing the position information at each time step, one can estimate the velocity v_{C} and its magnitude, the speed ν_{C} using distance traveled divided by the time difference between consecutive frames:

$$\begin{matrix}{v}_{C} = [ \begin{matrix}Δ {x}_{C} / Δ t \\ Δ {y}_{C} / Δ t\end{matrix} ] , & {v}_{C} = \frac{Δ {r}_{C}}{Δ t}\end{matrix} , \qquad ( 2 )$$

where Δx_{C} and Δy_{C} are the changes of the x and y coordinates between frames and

$$Δ {r}_{C} = \sqrt{Δ {x}_{C}^{2} + Δ {y}_{C}^{2}} .$$

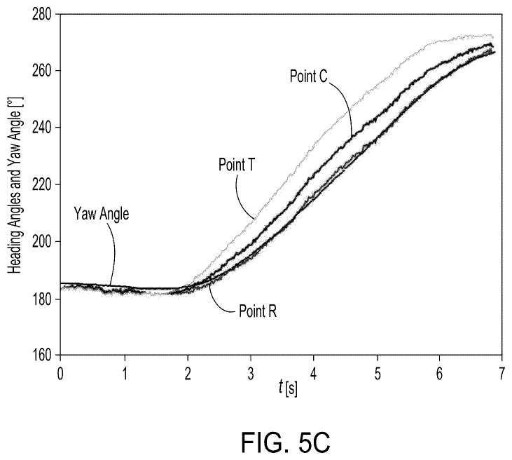

That is, the speed of the center point of the bounding box, is calculated by determining the distance between center points of two consecutive bounding boxes and dividing the distance by the time difference between consecutive frames. The velocity and the speed of the points T and R can be determined similarly. A direct division, however, can cause large errors. One pixel from the image is about 0.0275 m in reality, and the time difference is Δt= 1/60 s (with a frame rate of 60 fps). In this case, even an error of one pixel can lead to 0.0275×60=1.65 m/s when estimating the speed. Thus, the direct speed calculation is smoothed in the plots. FIG. 5A shows the smoothed speed curve at each point of the vehicle using 21 data points, which is corresponding to ⅓ s (⅙ s ahead and ⅙ s behind). Instead of the two-sided smoothing, one-sided smoothing which only uses the past information can also be adapted to apply the algorithm online. In the beginning of a trip, for about 2 seconds when the vehicle is moving straight to the intersection, the speed at the three points (T, C and R) are very close. However, when the vehicle starts to turn, the difference becomes obvious, and point T at the front of the vehicle has the largest speed. This is clearly shown in FIG. 5B, where the black curve is the longitudinal velocity and the green, blue, red curves are the lateral velocities of point T, C, and R, respectively. The longitudinal velocity is aligned with the vehicle orientation, and all three points have the same longitudinal velocity since the vehicle is considered as a rigid body and the bounding box is in fixed length. The lateral velocity is perpendicular to the longitudinal velocity. In the beginning two seconds, the lateral velocities are approximately zero at all three points, and when the turn starts, the lateral velocities at point T and C increase to different magnitudes while remains close to zero at point R. This shows that there is only small side slip at the rear wheels, and validates the assumption of the bicycle model.

The yaw rate,

$$ω = \frac{Δ ψ}{Δ t} ,$$

can be calculated in a similar way using the yaw angle of the vehicle. The smoothed curves of speed and yaw rate and their original data (position/yaw angle difference divided by time difference) are plotted in FIG. 3. Here, the heading angle θ is given by the velocity direction, and varies at different points. FIG. 5C gives the heading angles calculated by the velocity directions at point T, C, and R. For comparison, the yaw angle obtained from the bounding box is also plotted as a black curve. Point T has the largest heading angle, and the heading angle at point R is very close to the yaw angle (β_{R}≈0).

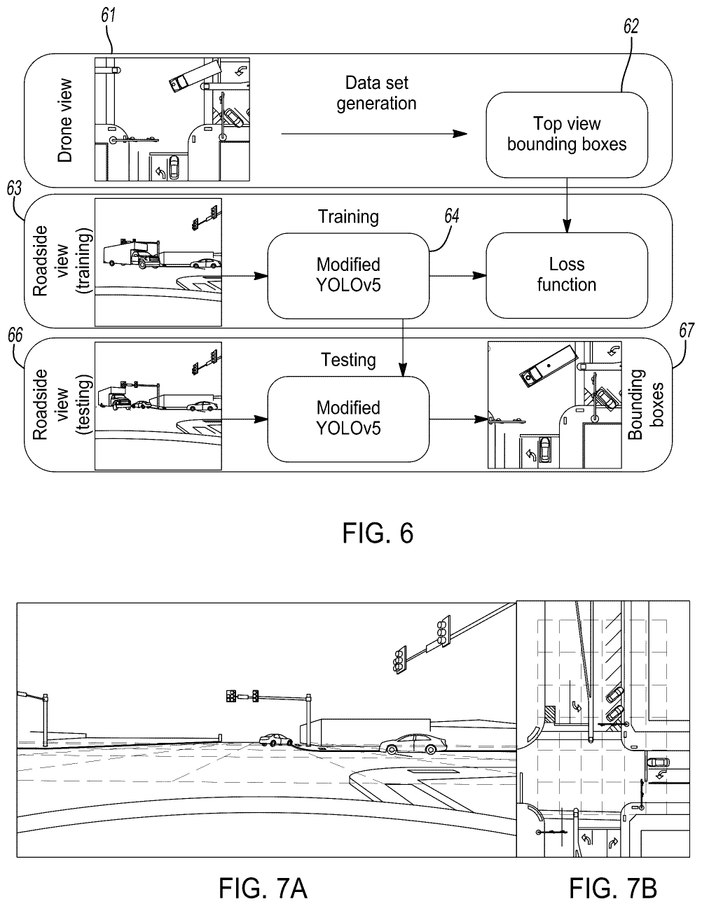

FIG. 6 depicts a vehicle position recognition technique using a modified neural network. In an example embodiment, the You Only Look Once (YOLOv5) convolutional neural network serves as the basis of the proposed algorithm. The structure of the original YOLOv5 object detection model is modified to incorporate the discrepancy between the input (roadside view images) and the output (top view data), and the optimization method is modified to include kinematic information in the algorithm. While reference is made throughout this disclosure to YOLO, it is readily understood that the techniques described herein are applicable to other types of convolution neural networks and machine learning algorithms.

Originally, the YOLO objection detection model maps the bounding boxes onto the input image. The goal, however, is not to obtain the bounding boxes on the roadside image but to reconstruct the top view bounding boxes of the vehicles. The top view perspective can be converted to the roadside view perspective with a homography transformation matrix, which can be obtained by selecting reference points from both perspectives. By decoupling the output space of the YOLOv5 model from the input image and mapping the detection results on the top view, the neural network is trained to learn the homography transform connecting the top view images and roadside view images. This approach is referred to herein as YOLOgraphy.

The original YOLOv5 model output contains the center point, width, and height of the bounding boxes, while the orientation of the detected object is missing. To incorporate this, an additional parameter (representing the yaw angle) is added to the output of YOLOv5 model, and the loss function is extended with this parameter. Similar to the original YOLOv5 algorithm, one can detect the objects on three different grids (20×20, 40×40 and 80×80). Depending on the size of the object, the network detects them on different grid layers, larger-sized objects on the coarser grids and smaller objects on the finer grids. A sample grid (6×6) is shown in FIGS. 7A and 7B. For each grid-cell, the output of the algorithm is

$$p = {[ {p}_{1} {b}_{x} {b}_{y} {w}_{x} {w}_{y} φ ]}^{⊤} , \qquad ( 1 )$$

where p₁∈[0, 1] is the confidence of an object being present in the given grid-cell, bx and by denote the bounding box center point positions within the cell relative to the top left corner of the grid-cell. For example, bₓ=b_{y}=0.5 represents the centerpoint, while bₓ=b_{y}=1 corresponds to the bottom right corner of the grid-cell. Outputs wₓ≥0 and w_{y}≥0 are the width and height of the bounding box as the scaling factors of the anchor box, and φ=ψ/(2π)∈[0, 1] is the newly introduced output, the normalized yaw angle of the bounding box (vehicle).

Originally, YOLOv5 object detection model used different anchor boxes. In many cases, it is optimal to have horizontal/vertical rectangles and a square as three anchor boxes, for example, vertical for a pedestrian, horizontal for a vehicle, and square for a cyclist in side view. In this solution, the introduction of the yaw angle makes such differentiation of the anchor boxes redundant, namely, horizontal and vertical rectangles can be transformed into each other by a 90-degree rotation. Hence, the proposed algorithm is based on a single anchor box.

The loss function in the YOLOv5 training consists of three main parts: the classification loss (cls loss), the objectness loss (obj loss), and the bounding box regression loss (box loss). The classification loss corresponds to the classification of the detected objects and is excluded from the study at this stage. The objectness loss shows the confidence of an object being present in a grid cell and is kept as it is. Lastly, the bounding box regression is modified to include the yaw angle. Originally, the box loss was calculated based on the Intersection over Union (IoU) algorithm, which divided the area of the intersection of the predicted and ground truth bounding boxes with the area of the union of the two (IoU is 1 if they overlap perfectly). When the bounding boxes are not aligned horizontally/vertically due to their non-zero yaw angles, the calculation of the intersection of the boxes is a more complex geometric problem. Thus, it may be computationally more efficient to use a simple mean-squared-error-based loss for the regression instead of the IoU. A weighted sum of position loss, size loss and the yaw loss is introduced as

$$loss = obj\_loss + α \cdot pos\_loss + β \cdot size\_loss + γ \cdot yaw\_loss , \qquad ( 2 )$$

where α, β and γ are tunable dimensionless hyperparameters, and are chosen to be 5, 1 and 10, respectively. These hand-tuned parameters and the mean squared error-based loss function perform well for the current experiments, but may be learned and modified. These results provide a proof of concept that can be extended with additional measurements in the future.

With continued reference to FIG. 6, an improved method for detecting a vehicle passing through a region of interest is described. First, a first set of images of the region of interest are captured at 61, where the first set of images are captured from a perspective above the region of interest, for example by a top view camera. From the first set of images, a plurality of bounding boxes for each vehicle moving in the region of interest is created and kinematic data for each vehicle moving in the region of interest is extracted using the plurality of bounding boxes as indicated at 62.

Similarly, a second set of images of the region of interest are captured at 63, where the second set of images is captured from a perspective on side of the region of interest, for example by a side view camera. A machine learning algorithm is then trained at 64 to detect moving vehicles in images captured by the side view camera. The machine learning algorithm is trained using the second set of images, a loss function, and a ground truth, where the kinematic data and the plurality of bounding boxes from the first set of images serve as the ground truth. It is noted that the loss function accounts for a yaw angle of the bonding boxes and the yaw angle defines orientation of a vehicle on ground plane. In the example described above, the machine learning algorithm is the modified YOLOv5 neural network although other types of machine learning models fall within the scope of this disclosure. An example system for implementing this method includes a top view camera and a side view camera interfaced with a computing device.

Once the machine leaning algorithm is trained, it may be used to detect vehicles passing though the region of interest. More specifically, an additional set of images of the region of interest is captured at 66 by the side view camera. Vehicles are then detected at 67 by inputting the additional set of images into the trained machine learning algorithm, thereby resulting in vectors representing bounding boxes for each vehicle detected in the region of interest. As described above, kinematic information for a vehicle can be determined using the vectors (i.e., bounding boxes), including but not limited to position, speed and yaw angle of the vehicle.

Kinematic information for the vehicles can in turn be used in different safety application. For example, kinematic information may be broadcast from the computing device over a wireless network to nearby connected vehicles. The nearby vehicles can use the kinematic information to make and execute decisions. For example, an autonomous vehicle may stop to avoid hitting a pedestrian or another nearby vehicle. In another example, the computing device may execute an intersection management algorithm in part based on the kinematic information for vehicles in or near the intersection being monitored by the side view camera. Intersection management algorithms are readily found in the art. Based on the output from the intersection management algorithm, the computing device may control the traffic at the intersection, for example by triggering a traffic light to avoid a hazardous condition. These are merely examples of how the kinematic information for the moving vehicles can be used to monitor and control vehicles in or near the intersection.

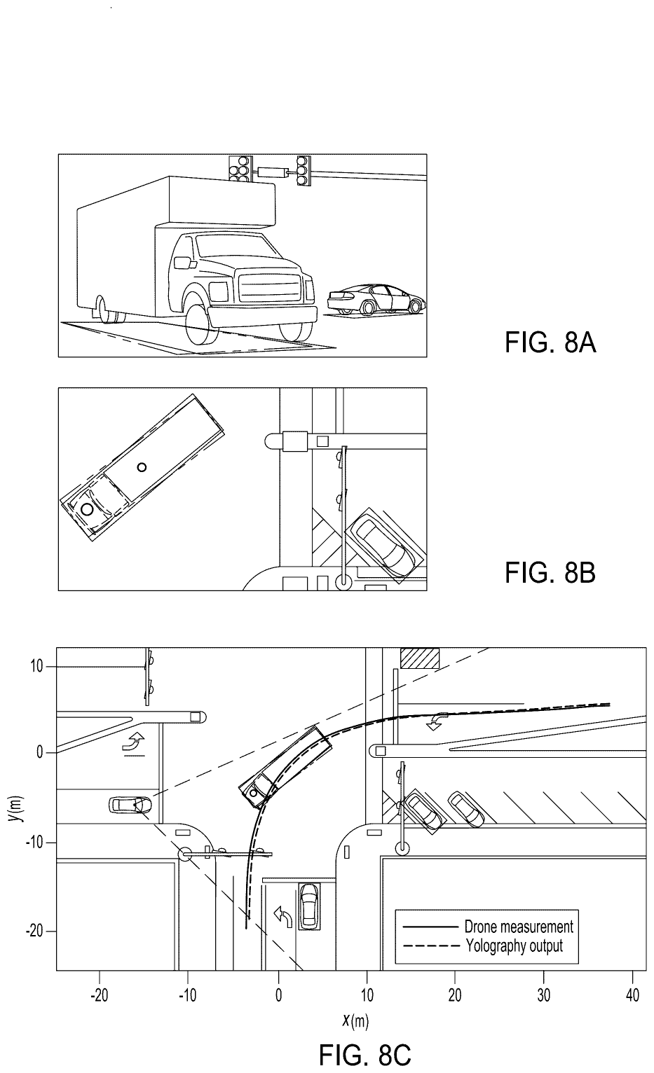

As proof of concept, two recordings (with the corresponding datasets) are used to train the neural networks separately, as the roadside camera has slightly different perspectives in the two cases, yielding different homography transformation matrices. For each dataset, the frames are mixed randomly, with 75% for training, 15% for validation, and 10% for testing. The neck and heads of the upper layer YOLOv5 network are trained, while the main convolutional layers are frozen during the training. This way, the network does not need to learn what a vehicle looks like but only learns how to place it on the top view plane. Overall, the networks perform well even for the test and validation sets, which were not used during training. In FIGS. 8A and 8B, the output of one experiment is visualized both in the roadside view panel (a) and the top view panel (b). The solid line bounding boxes are the ground truth obtained from drone measurements, and the dotted line bounding boxes are the YOLOgraphy output. The trajectory of the center point of the bounding box is shown in FIG. 8C. The dotted line curve (network prediction) and the solid line curve (ground truth) have good agreement, which validates the proposed approach.

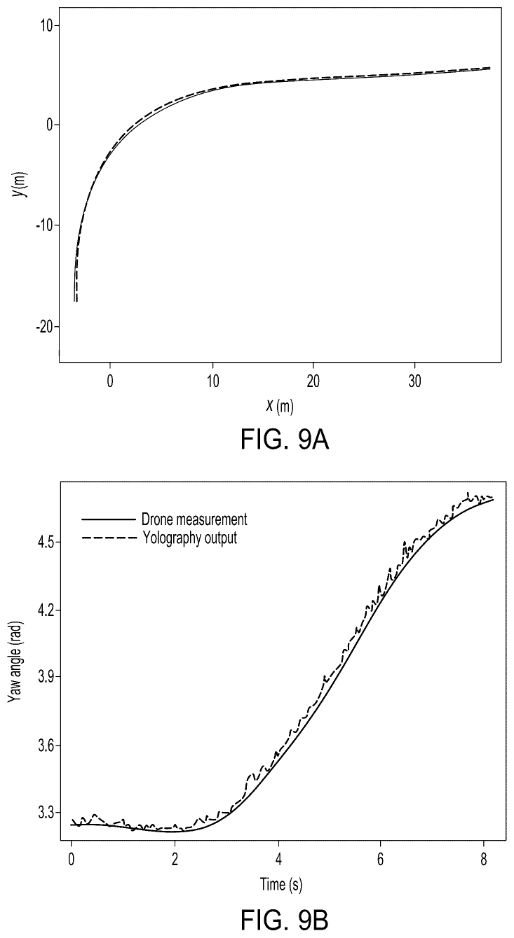

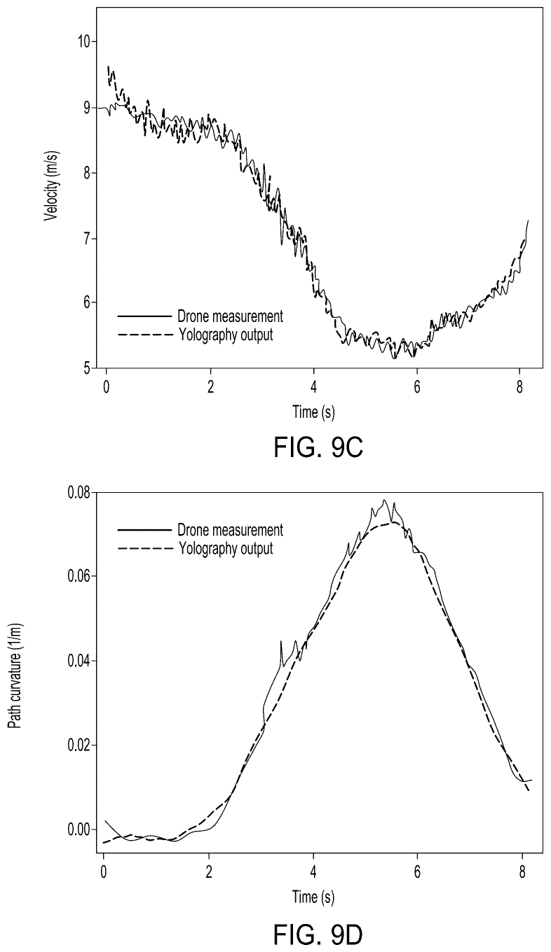

The results of the trained YOLOgraphy output are compared with the drone measurements (ground truth). The positions of one experiment are shown in FIG. 9A, where the dashed line is the YOLOgraphy output, and the solid line is the ground truth. The two curves overlap with minimal difference throughout the whole measurement. Note that the visualization includes all the training, validation, and test frames. The yaw angles are compared in FIG. 9B. While the two curves have good agreement, the YOLOgraphy output looks more noisy. This suggests that the YOLOgraphy struggles more with the prediction of the yaw angle, which is expected since it is a challenging task to predict the yaw angle based on the roadside view (cf. FIG. 7 and FIG. 8A).

In FIG. 9C, the speed of the rear axle center (RAC) point is plotted, and since the RAC's velocity aligns with the yaw angle, this is referred to as longitudinal velocity. Between 5 and 6 seconds, the velocity hits the minimum, which is at the apex of the turning. The velocity of the drone measurement and the YOLOgraphy output show a good agreement. Since these values are calculated with the method of finite differences, it is expected to amplify the noise.

In FIG. 9D, the curvature of the rear axle center (RAC) is shown. Assuming that the RAC's heading angle is close to the yaw angle, the curvature is calculated from the yaw angle as κ=Δψ/Δs where Δψ is the change in the yaw angle between two adjacent frames, and As is the distance between two positions. To smooth the data, a Savitzky-Golay filter is applied. The curvature from YOLOgraphy is (somewhat surprisingly) smoother compared to the drone measurement.

This work provides a proof of concept of YOLOgraphy, based on a modified YOLOv5 neural network. The roadside view images are mapped to the top view, and the neural network essentially learns the transformation during training. After training, YOLOgraphy can take the images from a roadside camera as input and output the kinematic data of vehicles on the top view plane. The validation results demonstrate the feasibility of the proposed method.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for detecting a vehicle passing through a region of interest, comprising:
capturing, by a side view camera, a set of images for a region of interest on the ground from a perspective on side of the region of interest;
providing a neural network model configured to receive images of the region of interest captured from a perspective on side of the region of interest and trained to output vectors representing bonding boxes for each vehicle detected in the region of interest from a perspective above the region of interest, where the vectors include a yaw angle for the bounding boxes and the yaw angle defines orientation of a vehicle on ground plane; and
detecting, by a computer processor, vehicles in the region of interest by inputting the set of images into the neural network model.

2. The method of claim 1 further comprises determining kinematic information for the detected vehicles and broadcasting the kinematic information over a wireless network to vehicles in or near the region of interest.

3. The method of claim 1 wherein the vectors output by the neural network are comprised of a center position of a given bounding box relative to a grid; a width of the given bounding box, a length of the given bounding box, a confidence of the vehicle being present in the given bounding box and the yaw angle for the given bounding box.

4. The method of claim 1 further comprises
capturing, by a top view camera, a first set of images of a region of interest on the ground from a perspective above the region of interest;
from the first set of images, creating a plurality of bounding boxes for each vehicle moving in the region of interest, and extracting kinematic data for each vehicle moving in the region of interest using the plurality of bounding boxes;
capturing, by the side view camera, a second set of images of the region of interest from a perspective on side of the region of interest; and
training the neural network model using the second set of images and a ground truth, where the kinematic data and the plurality of bounding boxes projected to onto the region of interest on the ground serve as the ground truth.

5. The method of claim 4 wherein the neural network model is trained using a loss function and the loss function accounts for the yaw angle of the bonding boxes.

6. The method of claim 5 wherein the loss function is further defined as
$$loss = obj\_loss + pos\_loss + size\_loss + yaw\_loss$$
where obj_loss indicates confidence of the vehicle being present in a cell, pos_loss accounts for disparity of center point of bounding boxes between the output and the ground truth, size_loss indicates a size difference of bounding boxes between the output and the ground truth, and yaw_loss indicates a difference between the yaw angle and the ground truth.

7. A method for detecting a vehicle passing through a region of interest, comprising:
receiving a first set of images of a region of interest on the ground from a perspective above the region of interest;
from the first set of images, creating a plurality of bounding boxes for each vehicle moving in the region of interest, and extracting kinematic data for each vehicle moving in the region of interest using the plurality of bounding boxes;
capturing, by a side view camera, a second set of images of the region of interest from a perspective on side of the region of interest; and
training a machine learning algorithm to detect moving vehicles in images captured by the side view camera, where the machine learning algorithm is trained using the second set of images, a loss function, and a ground truth, such that the loss function accounts for a yaw angle of the bonding boxes, the yaw angle defines orientation of a vehicle on ground plane, and the kinematic data and the plurality of bounding boxes projected onto the region of interest serve as the ground truth.

8. The method of claim 7 further comprises
capturing, by the side view camera, an additional set of images of the region of interest; and
detecting, by a computer processor, vehicles in the region of interest by inputting the set of images into the trained machine learning algorithm.

9. The method of claim 8 further comprises determining kinematic information for the detected vehicles and broadcasting the kinematic information over a wireless network to vehicles in or near the region of interest.

10. The method of claim 7 wherein the loss function is further defined as
$$loss = obj\_loss + pos\_loss + size\_loss + yaw\_loss$$
where obj_loss indicates confidence of the vehicle being present in a cell, pos_loss accounts for disparity of center point of bounding boxes between the output and the ground truth, size_loss indicates a size difference of bounding boxes between the output and the ground truth, and yaw_loss indicates a difference between the yaw angle and the ground truth.

11. A non-transitory computer-readable medium having computer-executable instructions that, upon execution of the instructions by a processor of a computer, cause the computer to
receive a first set of images of a region of interest on the ground from a perspective above the region of interest;
from the first set of images, create a plurality of bounding boxes for each vehicle moving in the region of interest, and extract kinematic data for each vehicle moving in the region of interest using the plurality of bounding boxes;
capture a second set of images of the region of interest from a perspective on side of the region of interest using a side view camera; and
training a machine learning algorithm to detect moving vehicles in images captured by the side view camera, where the machine learning algorithm is trained using the second set of images, a loss function, and a ground truth, such that the loss function accounts for a yaw angle of the bonding boxes, the yaw angle defines orientation of a vehicle on ground plane, and the kinematic data and the plurality of bounding boxes projected onto the region of interest serve as the ground truth.
